(19) United States
(12) Patent Application Publication
(10) Pub. No.: US 2009/0153445 A1
(43) Pub. Date: Jun. 18, 2009

(54) Capacitive coupling-type transmitting and receiving circuits for information signal

(75) Inventors: Futoshi Furuta, Kokubunji (JP); Hiroshi Kageyama, Hachioji (JP); Ken Takei, Kawasaki (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/314,579

(22) Filed: Dec. 12, 2008

(30) Foreign Application Priority Data
Dec. 13, 2007 (JP) 2007-321595

(51) Int. Cl. G09G 3/30

(52) U.S. Cl. 345/76

(57) ABSTRACT

A capacitive coupling-type transmitting and receiving circuit for information signal is provided in which attenuation of a signal on a non-contact transmission path via a capacitor and a change of voltage on the receiving side due to a slight change in capacitance are suppressed, modulation and demodulation processes of signals are unnecessary, and non-contact transmission which does not depend on the transmission rate is enabled. The capacitor is formed with a transmitting electrode on a transmission board and a receiving electrode on a display panel board, and an insulating member is interposed between the electrodes. The transmitting board comprises a transmission signal processing circuit which converts display data from an external signal source into a voltage signal. The display panel board comprises an impedance converter circuit and a reception signal processing circuit.

### CLAIM OF PRIORITY

The present application claims priority from Japanese application JP 2007-321595 filed on Dec. 13, 2007, the content of which is hereby incorporated by reference into this application.

### BACKGROUND OF THE INVENTION

1. Field of the Invention

The present invention relates to a captive coupling-type transmitting and receiving circuit for information signal, for non-contact transmission of display information from a signal source to a display panel, and, in particular, to such a circuit preferable for a portable information terminal for which a low power consumption is desired.

2. Description of the Related Art

If display information to a display panel such as a liquid crystal panel and an organic electroluminescence panel is electrically transmitted from a signal source in a non-contacting system, the line materials to be provided on the display panel can be omitted, and, consequently, the cost of the panel equipment can be reduced and fabrication steps can be simplified. In addition, such a structure contributes to expansion of application range of the display panel.

With regard to this type of technique, JP 2005-301219 A discloses an active matrix display apparatus which uses a thin film transistor (TFT) wherein image data is received from an external system through a non-contact transmission path, processed, and displayed. The non-contact transmission path in this reference uses an electrostatic capacitive coupling structure in which an electrode provided on the side of the display apparatus and an electrode provided on the side of transmitting the signal are closely placed.

As other communication methods via a non-contact transmission path, an electromagnetic induction method and an electromagnetic wave method are known, in addition to the above-described electrostatic capacitive coupling (which may alternatively be called “electrostatic induction” or simply “capacitive coupling”). In the electromagnetic wave method and the electromagnetic induction method, the display signal must be modulated using a carrier wave having a higher frequency, and then demodulated. Because of this, a high processing capability (response speed) is required for the circuit element on the side of the display panel, and it is difficult to transmit through these methods using a thin film transistor (TFT) on the display panel. In addition, the power consumption of the circuit is high. Moreover, in the electromagnetic induction method, a coil and a capacitor for resonance must be formed for each transmission channel on the display panel, which results in an increase in the equipment area.

In the capacitive coupling method, on the other hand, the area can be set small because the path can be formed with only the transmission electrodes. However, because the reception conditions (such as voltage and transmission rate generated at the receiving side) are easily affected by a change in the capacitance between transmission and reception and a change in a direct current offset on the transmitting side, it has been difficult to achieve an operational structure.

An object of the present invention is to provide a capacitive coupling-type transmitting and receiving circuit for information signal in which attenuation of the signal in the non-contact transmission path via a capacitor and a change of a receiving side voltage due to a slight change in capacitance are suppressed, there is no necessity of modulation and demodulation processes of the signals, and the non-contact transmission which does not depend on the transmission rate is enabled.

### SUMMARY OF THE INVENTION

(1) According to one aspect of the present invention, there is provided a capacitive coupling-type transmitting and receiving circuit for information signal in which display data is transmitted via a non-contact transmission path comprising a display panel board having a display section, a transmitting board which supplies the display data to be displayed on the display section to the display panel board, and a capacitor which is formed between the transmitting board and the display panel board.

The transmitting board comprises an insulating board, a transmission signal processing circuit which is formed over the insulating board and which converts the display data from an external signal source into a voltage signal, and a transmitting capacitor electrode. The display panel board comprises an insulating board, a receiving capacitor electrode which is formed over the insulating board, an impedance converter circuit, and a reception signal processing circuit. A capacitive coupling electrode pair is formed by the transmitting capacitor electrode and the receiving capacitor electrode, and an insulating member is interposed between the transmitting capacitor electrode and the receiving capacitor electrode of the capacitive coupling electrode pair, to form the capacitor. The voltage signal obtained at the receiving capacitor electrode is supplied via the impedance converter circuit to the reception signal processing circuit which converts the voltage signal to the display data to be displayed on the display section.

(2) According to another aspect of the present invention, it is preferable that, in the capacitive coupling-type transmitting and receiving circuit for information signal described in (1), the insulating member which is a part of the capacitive coupling electrode pair is the insulating board which is a part of the display panel board.

(3) According to another aspect of the present invention, it is preferable that, in the capacitive coupling-type transmitting and receiving circuit for information described in (1), a plurality of the capacitive coupling electrode pairs are provided, a reference signal is transmitted with one of the plurality of the capacitive coupling electrode pairs, and the display data is transmitted with the other capacitive coupling electrode pairs.

(4) According to another aspect of the present invention, it is preferable that, in the capacitive coupling-type transmitting and receiving circuit for information signal described in (1), three capacitive coupling electrode pairs are provided, binary display data is transmitted with a first capacitive coupling electrode pair, a reference signal (clock signal) is transmitted with a second capacitive coupling electrode pair, and a reference potential is transmitted with a third capacitive coupling electrode pair.

(5) According to another aspect of the present invention, it is preferable that, a reference signal and a display data comprise a unit pulse, which comprises three types of voltage levels including an H level (V_{H}), an L level (V_{L}), and an offset voltage (Voff).

(6) According to another aspect of the present invention, it is preferable that, in the capacitive coupling-type transmitting and receiving circuit for information signal described in (1), the reception signal processing circuit converts the voltage signal to the display data by a pulse logic-to-level logic conversion.

With the various aspects of the present invention, the following advantages were realized; (1) because the impedance converter circuit is provided near the receiving capacitor electrode on a display panel board which is the receiving board, it is possible to suppress attenuation of signals in the non-contact transmission path via the capacitor and a change in the receiving side voltage due to a slight change in capacitance; (2) because the reference signal (clock signal) is separated from the display data signal, the modulation and demodulation of the signal becomes unnecessary and non-contact transmission is enabled which does not depend on the magnitude of the transmission rate or on the presence or absence of data; (3) reduction of an input margin on the side of the display panel due to a change in a direct current component (offset component) contained in a signal which is output from the transmitting board can be prevented by cancelling the change with a voltage of an offset level which is prepared in advance; and (4) a display panel with non-contact transmission can be realized by merely adding a pulse logic-to-level logic converter circuit to the panel circuit of related art.

In addition, with the present invention, a flat cable board which connects the transmitting board and the display panel board becomes unnecessary. Therefore, such a structure is preferable for formation of the display section in the display panel board and reduction of the power consumption in a liquid crystal display or an organic electroluminescence display to which the structure is equipped. In addition, the present invention can also be applied to a unit display forming a part of a large-size display for outdoor placement.

### BRIEF DESCRIPTION OF THE DRAWINGS

In the accompanying drawings:

FIGS. 1A and 1B are schematic structural diagrams of a display apparatus for explaining a first preferred embodiment of the present invention;

FIG. 2 is a circuit diagram for explaining an example structure of an impedance converter circuit 16 in FIGS. 1A and 1B;

FIGS. 3A-3E are waveform diagrams for explaining a definition of a signal optimum for capacitive coupling in the present invention;

FIGS. 4A-4C are diagrams for explaining a level change of a transmission circuit which uses capacitive coupling;

FIGS. 5A-5D are waveform diagrams for explaining a change of a direct current offset in capacitive coupling;

FIGS. 6A and 6B are diagrams showing an example of and an operation voltage waveform of a unit pulse generating circuit which realizes a level logic-to-pulse logic conversion on the side of the transmitting board;

FIG. 7 is a diagram explaining an example structure of a level logic-to-pulse logic converter circuit which uses a unit pulse generating circuit of FIGS. 6A and 6B;

FIGS. 8A and 8B are diagrams showing an example structure of and explaining an operation of a pulse logic-to-level logic converter circuit on the side of the display panel board;

FIGS. 9A and 9B are schematic structural diagrams of a display apparatus for explaining a second preferred embodiment of the present invention;

FIG. 10 is an explanatory diagram of another example structure of a level logic-to-pulse logic converter circuit on the side of the transmitting board; and

FIGS. 11A and 11B are diagrams showing another example structure of and an operation waveform of a pulse logic-to-level logic converter circuit provided on the display panel board for explaining a third preferred embodiment of the present invention.

### DETAILED DESCRIPTION OF THE INVENTION

Preferred embodiments of the present invention will now be described in detail.

### FIRST PREFERRED EMBODIMENT

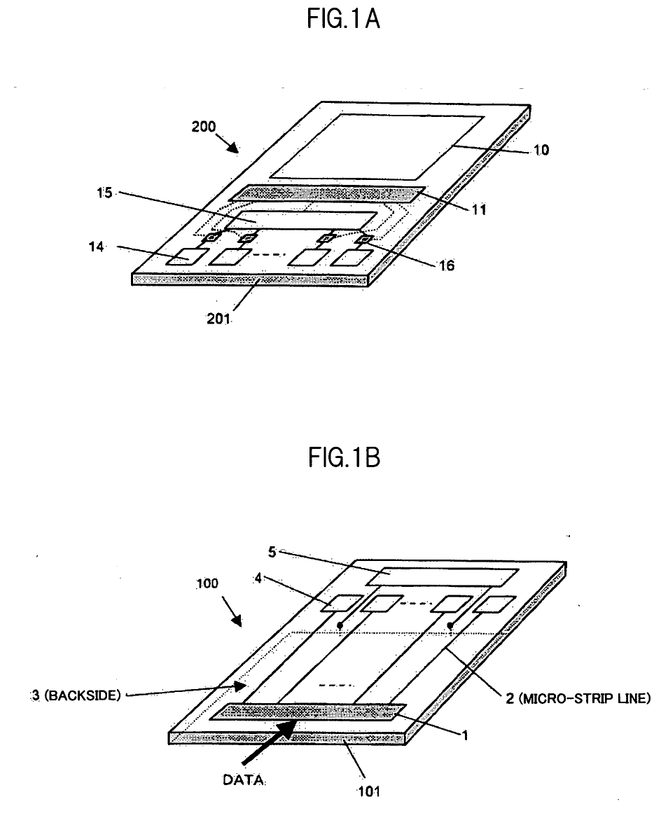

FIGS. 1A and 1B are schematic structural diagrams of a display apparatus for explaining a first preferred embodiment of the present invention. In the display apparatus, the capacitive coupling-type transmitting and receiving circuit for information signal of the present invention is equipped. FIG. 1A shows a display panel board 200 and FIG. 1B shows a transmitting board 100. In the display panel board 200, a display section 10 is formed or equipped over an insulating board 201 which is preferably made of glass. The display section 10 refers to a liquid crystal display apparatus or the like. In addition, a reception signal processing circuit 11, a plurality of receiving capacitor electrodes 14 and 15, and an impedance converter circuit 16 connected to the receiving capacitor electrode 14 are formed over the insulating board 201. The receiving capacitor electrode 15 is provided for maintaining a common potential for the other receiving capacitor electrodes.

On the other hand, over an insulating board 101 which is a part of the transmitting board 100, a transmission signal processing circuit 1 to which a display signal (which is also called a display data signal) DATA from an external signal source is input and which processes the display signal DATA, a transmission line (micro-strip line) comprising a signal line 2 and a backside earth electrode 3, and a plurality of transmitting capacitor electrodes 4 and 5 are formed. The transmitting capacitor electrodes 4 and 5 of the transmitting board 100 are layered opposing the receiving capacitor electrodes 14 and 15 of the display panel board 200. In this process, the insulating board 201 becomes the insulating members of the capacitive coupling electrode pairs formed by the transmitting capacitor electrodes 4 and 5 and the receiving capacitor electrodes 14 and 15.

More specifically, capacitors are formed by sandwiching the insulating board 201 which is an insulating layer of the display panel with the capacitive coupling electrode pairs which are formed over the transmitting board 100 and the display panel board 200 (that is, transmitting capacitor electrodes 4 and 5 and the receiving capacitor electrodes 14 and 15), and non-contact transmission paths are formed by the capacitors.

Here, a case is considered in which a transmission signal is transmitted using one capacitive coupling electrode assigned for each signal and a common electrode assigned for all signals (unbalanced transmission). Next, each constituting element will be described along with the flow of the display data signal. At the transmitting board 100, a data signal supplied from an external signal source is converted to a display data signal to be transmitted to the display panel board 200, in the transmission signal processing circuit 1, and an electric field is generated with the converted signal between the electrostatic inductive electrodes 4 and 5 via the transmission line on the board 101. In the case of the unbalanced transmission, as shown in FIG. 1B, the transmission line is formed by paring the signal line 2 and a common potential line (earth electrode 3), and is called a micro-strip line. When the distance between the transmission signal processing circuit 1 and the electrostatic coupling electrodes 4 and 5 is sufficiently shorter than the wavelength of a highest frequency component of the signal to be transmitted, the transmission line does not need to be provided.

As already described, capacitors for coupling are formed with the transmitting capacitor electrodes 4 and 5 over the transmitting board 100, the receiving capacitor electrodes 14 and 15 over the display panel board 200, and the insulating board 201. The voltage which is capacitively induced on the receiving capacitor electrode on the side of the display panel board 200 is immediately input to the impedance converter circuit 16 and is then output to the signal processing circuit 11.

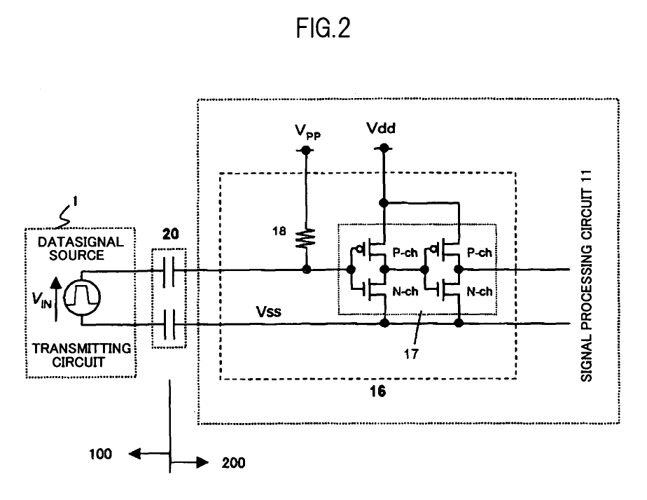

FIG. 2 is a circuit diagram explaining an example structure of the impedance converter circuit 16 of FIGS. 1A and 1B. As shown in FIG. 2, the impedance converter circuit 16 comprises a pull-up resistor 18 and a buffer circuit 17 comprising MOS-FETs and having a structure as shown in FIG. 2. When the pull-up resistor 18 is few MΩ or greater, the voltage generated between a gate and a source of the MOS-FET of the buffer circuit 17 is determined by a ratio of a coupling capacitance of the receiving capacitor electrodes of the capacitive coupling section 20 and a sum of a floating capacitance of a line between the electrode of the capacitive coupling section 20 and the source of the MOS-FET, where a voltage Vss occurs, and a floating capacitance of the gate electrode of the FET. Therefore, the floating capacitance of the line and the capacitance of the gate electrode of the FET must be sufficiently low compared to the coupling capacitance. Thus, the distance between the receiving capacitor electrode and the impedance circuit (the gate of the MOS-FET) must be minimized and the size of the gate electrode should be formed with a minimum size of the process.

On the other hand, because an output signal from the impedance converter circuit 16 to the reception signal processing circuit 11 can be propagated via a long transmission line within the display panel board 200, the placement of the reception signal processing circuit 11 can be determined relatively freely.

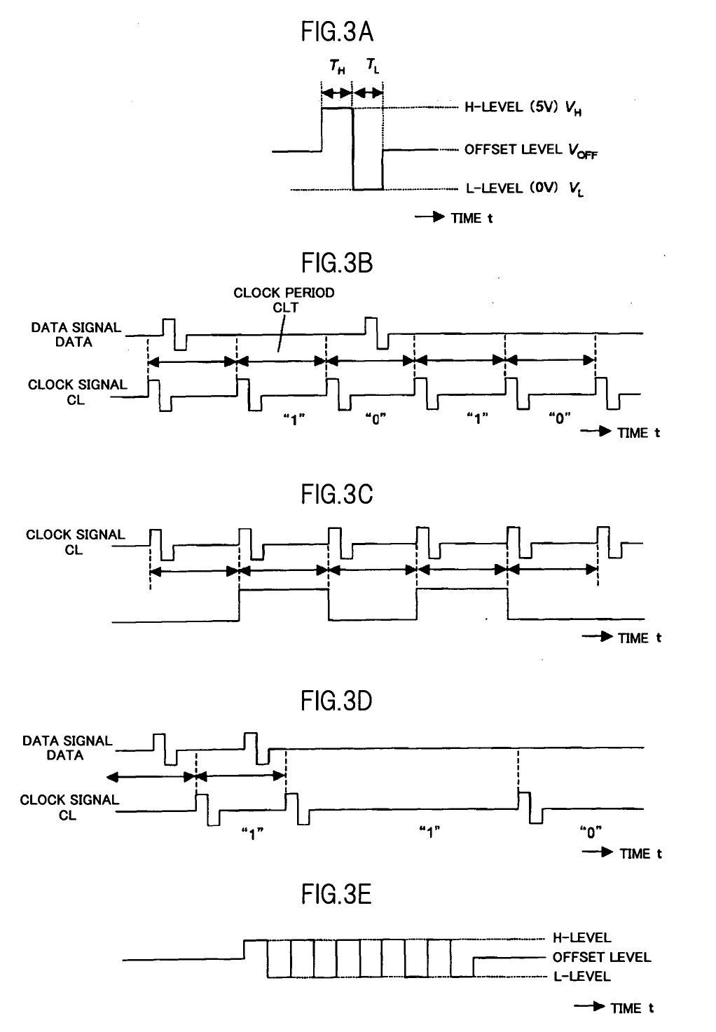

FIGS. 3A-3E are waveform diagrams for explaining a definition of a signal which is optimum for capacitive coupling in the present invention. First, as shown in FIG. 3A, a unit pulse is defined which comprises three types of voltage levels including an H level (V_{H}), an L level (V_{L}), and an offset voltage (Voff). The H level and the L level are values which depend on the circuit to be equipped. The offset voltage Voff, on the other hand, is a value defined by the following equation, with a width of the H level (V_{H}) being T_{H} and a width of the L level (V_{L}) being T_{L}:

(V_{H}T_{H}+V_{L}T_{L}/(T_{H}+T_{L}) (1)

Using the unit pulse defined as described above, a logic value is defined as shown in FIG. 3B. As a reference signal for the display signal (data signal), a clock signal CL in which a unit pulse is generated at a predetermined period is transmitted as one of the display signals. The clock signal CL becomes a reference signal for the display signal (data signal). A logic value of “1” is defined as a condition in which there is a pulse of the data signal between adjacent unit pulses of the clock signal CL and a logic value of “0” is defined as a condition in which there is no such a pulse. In reality, the determination of whether or not there is a pulse of the data signal between adjacent unit pulses of the clock signal CL cannot be made until a time period of a clock period CLT has elapsed, which is defined as the time between the adjacent unit pulses of the clock signal CL. Therefore, as shown in FIG. 3B, the logic value is determined at the next clock period CLT.

The generation of the pulse and the conversion from the level logic to the pulse logic are executed by the transmission signal processing circuit 1 of the transmitting board 100, and the restoration of the level logic from the pulse signal as shown in FIG. 3C is executed by the reception signal processing circuit 11 of the display panel board 200.

As shown in FIG. 3D, by extending the clock period CLT of the clock signal CL or by stopping transmission of the clock signal CL, it is possible to maintain the logic state at that time. Because of this, it is possible not only to transmit the display data, but also to apply a static control such as designation of an operation mode to the display panel board 200.

In addition, as shown in FIG. 3E, when the clock period CLT is short, the above-described unit pulse does not need to be generated. In this case, the clock signal CL may be a simple square wave, but the offset voltage must be maintained during the no-signal period.

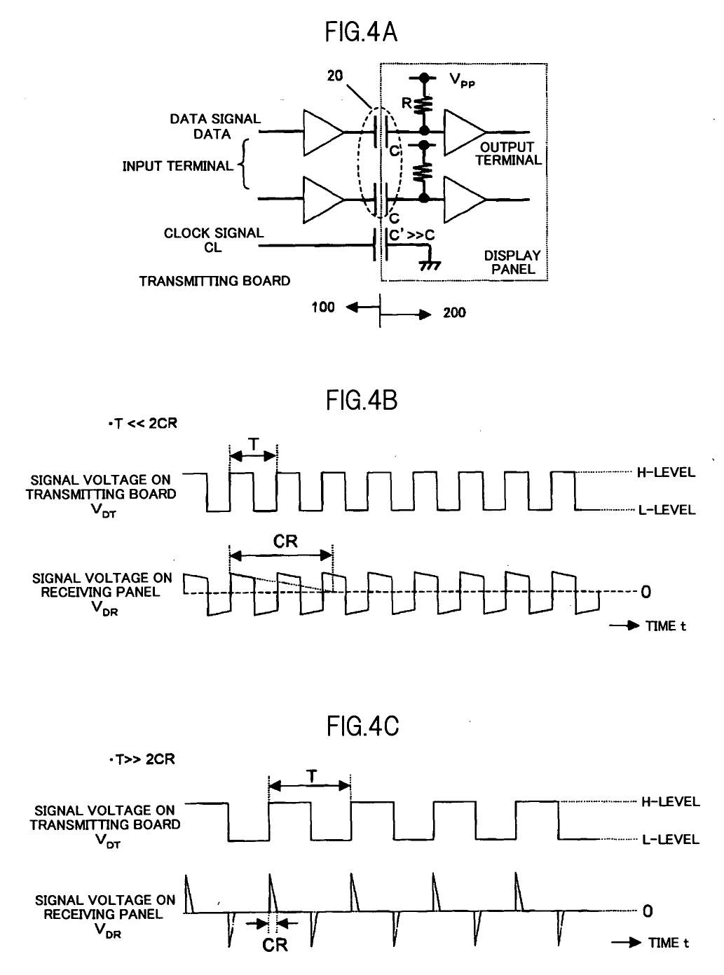

FIGS. 4A-4C show a level change of a transmission circuit which uses capacitive coupling. In general, in the case of the transmission circuit which uses capacitive coupling as shown in FIG. 4A, a voltage signal based on level logic of the related art changes according to the size of the coupling capacitor during transmission. When the period T of the data signal is shorter than the time constant determined by the pull-up resistor R and the coupling capacitance C on the side of the display panel board 200, the voltage waveform on the receiving side would be deformed as shown in FIG. 4B, but the level logic is transmitted. When, on the other hand, the period T is longer than the time constant, the voltage waveform on the receiving side would have a pulse shape as shown in FIG. 4C, and the level logic cannot be maintained.

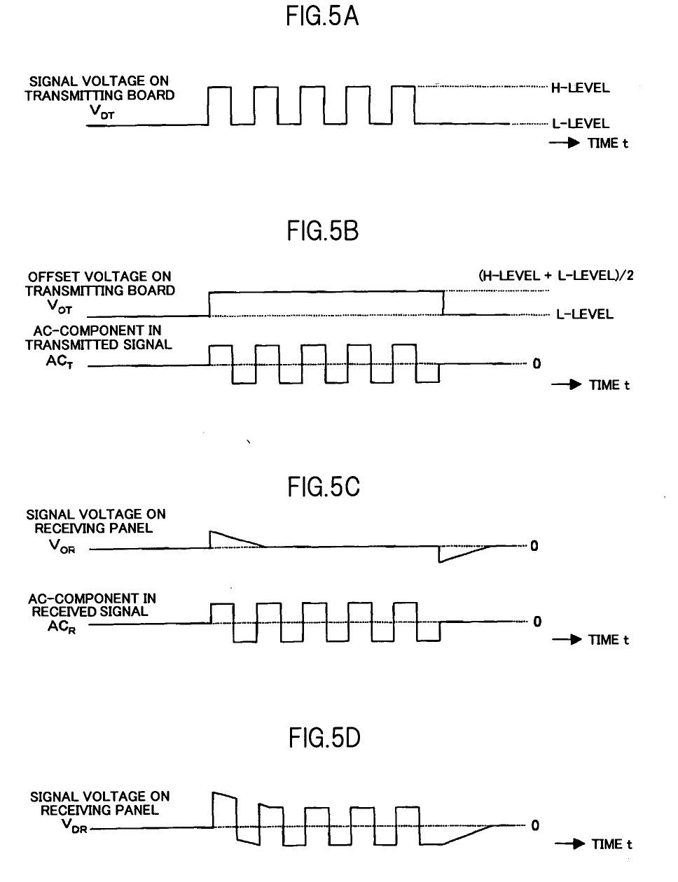

FIGS. 5A-5D are waveform diagrams showing a change of the direct current offset in capacitive coupling. In the capacitive coupling, a problem of a change of the direct current offset occurs. Here, a case is considered as shown in FIG. 5A in which the waveform V_{DT} and the no-signal state are repeatedly switched in the signal on the transmitting side. The alternate current component AC_{T} and the direct current component, that is, the direct current offset V_{OT} of this signal are shown in FIG. 5B. As a result of propagation of the signal through the capacitive coupling, the offset voltage and the alternate current component become those as shown in FIG. 5C at the side of the display panel board 200 which is the receiving side. Because of this, the signal on the receiving side is a voltage signal V_{DR} of FIG. 5D which is a combined waveform of the offset voltage V_{OR} and the alternate current component AC_{R}. In this system, because the maximum value or the minimum value of the voltage level of the square wave changes with time, the margin of the threshold value for determining the logic value in the subsequent circuits such as the reception signal processing circuit is significantly reduced.

In consideration of the above, in the present invention, the change in the direct current offset is resolved by defining the unit pulse as shown in FIG. 3A. With the level logic-to-pulse logic conversion based on the pulse logic of FIG. 3B, the problem that the voltage signal based on the level logic becomes a pulse shape due to the capacitive coupling has been solved.

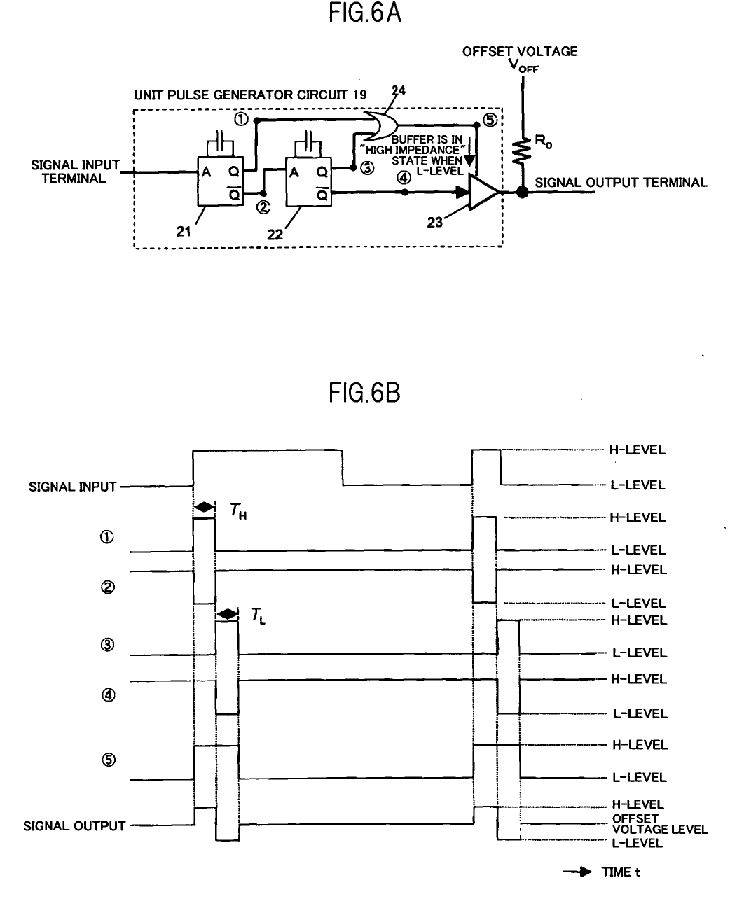

FIGS. 6A and 6B show an example of and an operation voltage waveform of a unit pulse generating circuit 19 which realizes the level logic-to-pulse logic conversion on the side of the transmitting board. The unit pulse generating circuit 19 which realizes the level logic-to-pulse logic conversion on the side of the transmitting board 100 shown in FIG. 6A primarily comprises two monostable multivibrators 21 and 22. The operation of the circuit will now be described along with the voltage waveforms shown in FIG. 6B. The waveforms of each section are correlated with the circled numbers.

At a rise of the input signal (L level→H level), the first multivibrator 21 is activated. Here, an output time T_{H} of the H level is determined. When the output of the multivibrator 21 returns to the L level, the second multivibrator 22 is activated, and an active time T_{L} is determined in the L level. During the time when either one of the two multivibrators 21 and 22 is active, a tri-state buffer 23 outputs an H level and an L level by a control signal. In the other periods, the tri-state buffer 23 is put in a high impedance state, and an offset voltage V_{OFF} is output via an offset resistor R_{O}.

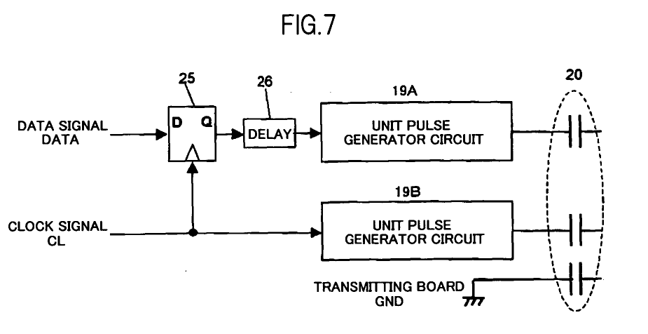

FIG. 7 is a diagram explaining an example structure of a level logic-to-pulse logic converter circuit which uses the unit pulse generating circuit of FIGS. 6A and 6B. The data signal DATA is temporarily retained in a flip-flop circuit 25 and is output at a rise of the clock signal CL. Then, the data signal is input to a unit pulse generating circuit 19A through a delay circuit 26. The clock signal CL is also input to a unit pulse generating circuit 19B. The signals are then supplied to the capacitive coupling section 20.

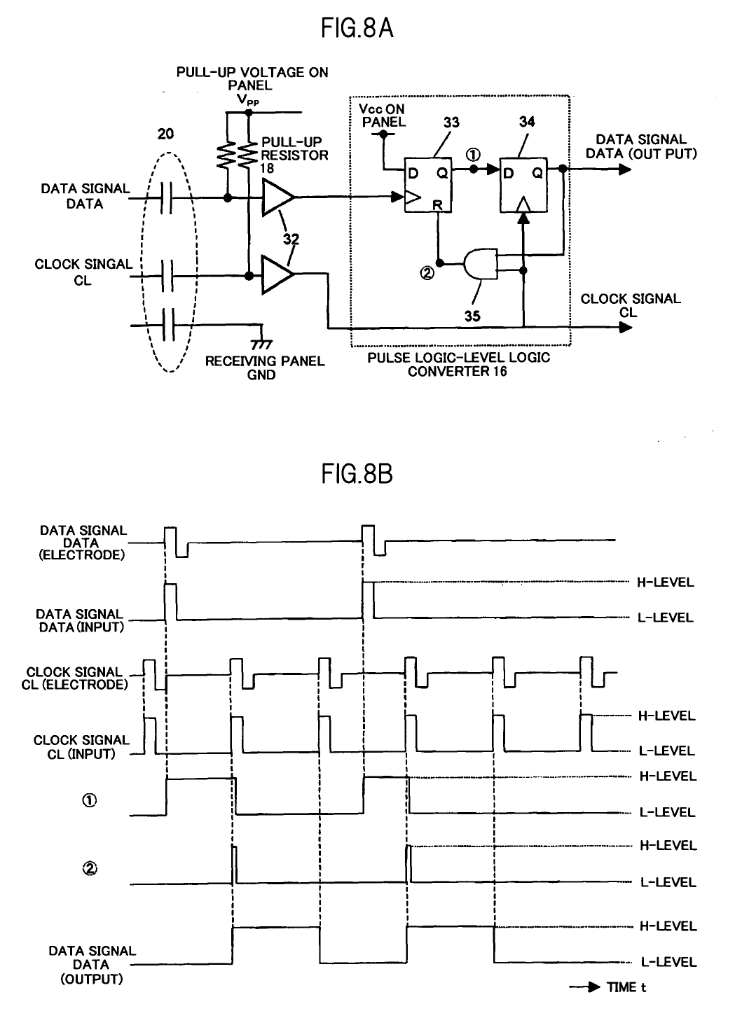

FIGS. 8A and 8B are diagrams explaining an example structure of and an operation of the pulse logic-to-level logic converter circuit on the side of the display panel board. FIG. 8A shows an example of a pulse logic-to-level logic converter circuit on the side of the display panel and FIG. 8B is voltage waveform diagrams for the shown structure. An operation of the circuit of FIG. 8A will now be described along with the voltage waveform diagrams shown in FIG. 8B. The data signal DATA and the clock signal CL induced on the side of the display panel board are converted into binary digital signals by buffers (here, impedance converter circuits 32), and then, are input to the converter circuit 16.

This circuit primarily comprises two D-flip-flop circuits 33 and 34. The first D-flip-flop circuit 33 having a reset outputs an H level at a rise of the data signal (L level→H level), and the H level is transmitted to the second D-flip-flop circuit 34. At the second flip-flop 34, the input level is read and output at a rise of the clock signal CL. When the output level of the second flip-flop 34 is the H level, the logic value of the clock signal CL is H, and, thus, the first flip-flop 33 is immediately reset through an AND gate 35.

This converter circuit 16 has a simple structure, however, there is a limitation in timing of the data input. In other words, a rise of the data signal cannot be detected during the period when the clock signal is at the H level.

### SECOND PREFERRED EMBODIMENT

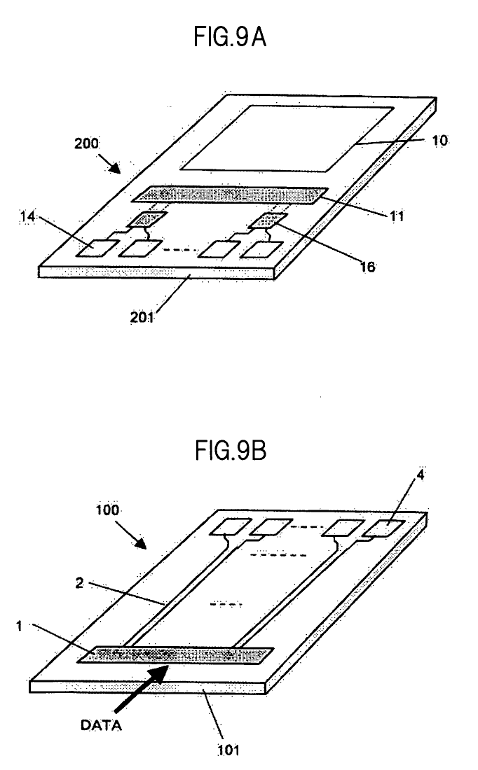

FIGS. 9A and 9B are schematic structural diagrams of a display apparatus for explaining a second preferred embodiment of the present invention. Similar to FIGS. 1A and 1B, structures of a transmitting board which transmits a display signal via a non-contact transmission path and of a display panel which receives the display signal via the non-contact transmission path are shown. A same reference numeral is assigned to a function portion which is identical to that of FIGS. 1A and 1B. In FIGS. 9A and 9B, a case is considered in which one transmission signal is transmitted by two capacitive coupling electrodes assigned for each signal (balanced transmission).

The operation at the transmitting board 100 is approximately similar to that of the first preferred embodiment. In the case of the balanced transmission, the transmission line 2 comprises a pair (two lines) of transmission lines including a signal line and an inverted signal line, and the structure is completely symmetric with respect to the transmission direction. When the distance between the signal processing circuit and the electrostatic inductive electrode is sufficiently shorter than the wavelength of a highest frequency component of the signal to be transmitted, no explicit transmission line is necessary. The structure of the coupling capacitors by the electrostatic inductive electrodes, a structure of the impedance converter circuit on the side of the display panel, and the condition of the placement are similar to those in the first preferred embodiment.

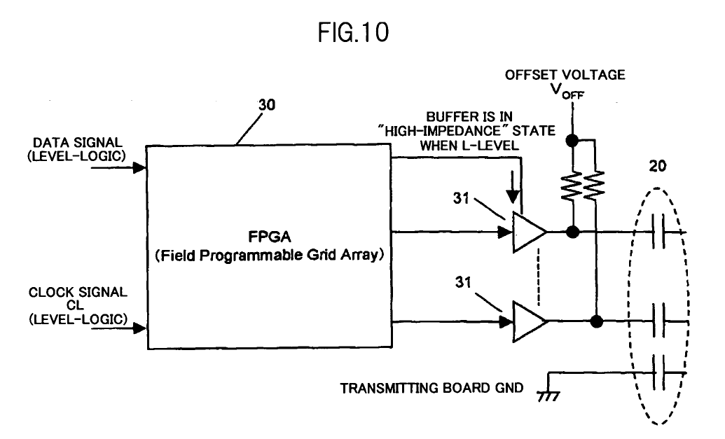

FIG. 10 is an explanatory diagram showing another example structure of a level logic-to-pulse logic converter circuit on the side of the transmitting board. As shown in FIG. 10, the control signal of the tri-state buffer 31 is output with an order circuit such as an FPGA (Field Programmable Grid Array) 30 according to timing of output of the data signal DATA (level logic) and clock signal CL (level logic).

### THIRD PREFERRED EMBODIMENT

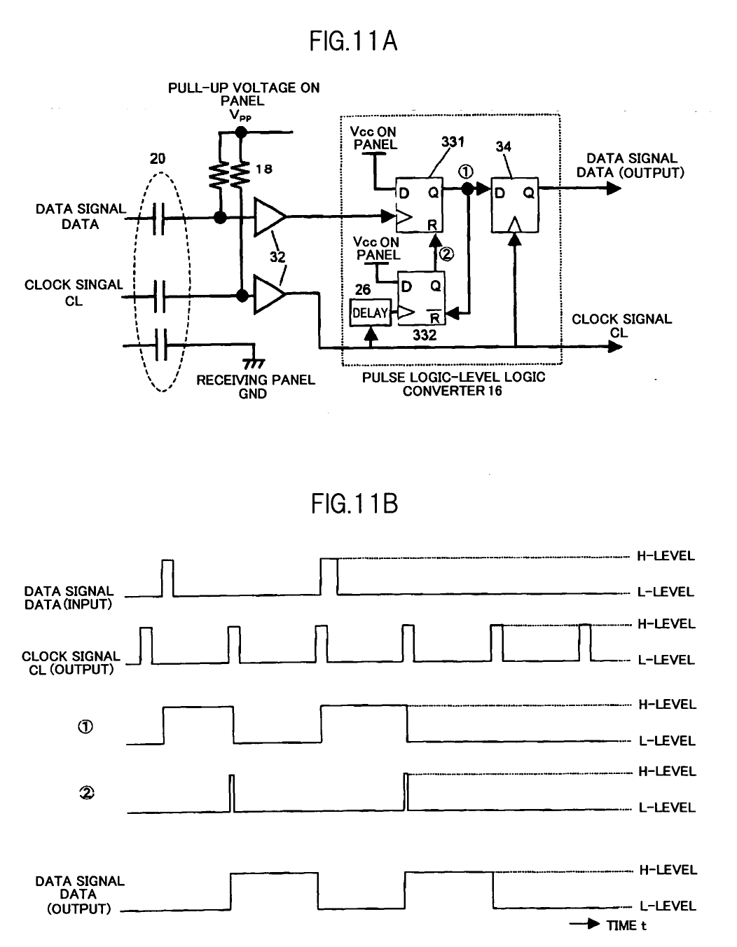

FIGS. 11A and 11B are diagrams which show another example structure of and an operation waveform of the pulse logic-to-level logic converter circuit 16 provided on the display panel board, for explaining a third preferred embodiment of the present invention. FIG. 11A shows another example structure of the pulse logic-to-level logic converter circuit on the side of the display panel board 200. As described above, the converter circuit 16 of FIG. 8A shown in the first preferred embodiment has a limitation on the timing for the data input. The circuit of FIGS. 11A and 11B, on the other hand, can detect a rise of the data input independently of logic states of the clock signal CL.

The converter circuit 16 primarily comprises three D-flip-flops 331, 332, and 34. An operation of the circuit will now be described along with the voltage waveforms shown in FIG. 11B. The data signal DATA and the clock signal CL which are induced on the side of the display panel board 200 are converted into binary digital signals by buffers (impedance converter circuits 32 in this example configuration), and then, are input to the converter circuit 40. The first D-flip-flop circuit 331 having a reset outputs an H level at a rise (L level→H level) of the data signal DATA, and the H level is transmitted to the second D-flip-flop 34. The second D-flip-flop 34 reads and outputs the input level at a rise of the clock signal CL. When the output level of the first flip-flop 331 is the H level, the first flip-flop 331 is reset at a rise of the clock signal CL at the D-flip-flop 332 having a reset.

What is claimed is:

1. A capacitive coupling-type transmitting and receiving circuit for information signal in which display data is transmitted via a non-contact transmission path comprising a display panel board having a display section, a transmitting board which supplies the display data to be displayed on the display section to the display panel board, and a capacitor which is formed between the transmitting board and the display panel board, wherein
the transmitting board comprises an insulating board, a transmission signal processing circuit which is formed over the insulating board and which converts the display data from an external signal source into a voltage signal, and a transmitting capacitor electrode,
the display panel board comprises an insulating board, a receiving capacitor electrode which is formed over the insulating board, an impedance converter circuit, and a reception signal processing circuit,
a capacitive coupling electrode pair is formed by the transmitting capacitor electrode and the receiving capacitor electrode, and an insulating member is interposed between the transmitting capacitor electrode and the receiving capacitor electrode of the capacitive coupling electrode pair, to form the capacitor, and
the voltage signal obtained at the receiving capacitor electrode is supplied via the impedance converter circuit to the reception signal processing circuit which converts the voltage signal to the display data to be displayed on the display section.

2. The capacitive coupling-type transmitting and receiving circuit for information signal according to claim 1, wherein
the insulating member which is a part of the capacitive coupling electrode pair is the insulating board which is a part of the display panel board.

3. The capacitive coupling-type transmitting and receiving circuit for information signal according to claim 1, wherein
a plurality of the capacitive coupling electrode pairs are provided, a reference signal is transmitted with one of the plurality of the capacitive coupling electrode pairs, and the display data is transmitted with the other capacitive coupling electrode pairs.

4. The capacitive coupling-type transmitting and receiving circuit for information signal according to claim 1, wherein
three capacitive coupling electrode pairs are provided, binary display data is transmitted with a first capacitive coupling electrode pair, a clock signal is transmitted with a second capacitive coupling electrode pair, and a reference potential is transmitted with a third capacitive coupling electrode pair.

5. The capacitive coupling-type transmitting and receiving circuit for information signal according to claim 1, wherein
the reception signal processing circuit converts the voltage signal to the display data by a pulse logic-to-level logic conversion.
